(19) United States
(12) Patent Application Publication
(10) Pub. No.: US 2019/0024501 A1
(43) Pub. Date: Jan. 24, 2019

(54) SEISMIC INVERSION CONSTRAINED BY REAL-TIME MEASUREMENTS

(71) Applicants: SCHLUMBERGER TECHNOLOGY CORPORATION, Sugar Land, TX (US); PRAD RESEARCH AND DEVELOPMENT LIMITED, Virgin Islands (VG)

(72) Inventors: Hilde Grude Borgos, Stavanger (NO); Lars Sønneland, Stavanger (NO)

(21) Appl. No.: 15/510,599

(22) PCT Filed: Sep. 4, 2015
(86) PCT No.: PCT/US15/48462

§ 371 Date: Mar. 10, 2017

(51) Int. Cl. E21B 47/022; G01V 1/28

(52) U.S. Cl. CPC E21B 47/02208; G01V 1/282; G01V 2210/67; G01V 2210/6169; G01V 2210/614

(57) ABSTRACT

A method is provided for constraining a seismic inversion using real-time measurements. The method comprises: receiving a seismic signal/seismic data; obtaining logging-while-drilling (LWD) measurements made during a drilling procedure; using the LWD measurements to constrain an inversion of the seismic signal/data; and using the inverted seismic signal/data to: obtain an image of a subterranean section of the Earth, determine properties of the subterranean section of the Earth and/or update a model of the subterranean section of the Earth.

### BACKGROUND

Embodiments of the present disclosure relate to a method for constraining a seismic inversion using real-time measurements.

Seismic surveying is generally performed by imparting energy to the earth at one or more source locations, for example, by way of controlled explosion, mechanical input etc. Return energy is then measured at surface receiver locations at varying distances and azimuths from the source location. The travel time of energy from source to receiver via the rock material making up the subsurface, via reflections and refractions from interfaces of subsurface strata, indicates properties of the strata, such as the depth and orientation of the strata. As such, seismic surveys provide for generating signals that contain information regarding the rock/rock structures and materials contained in the rock structures of a subsurface section of the Earth. Seismic surveying is performed using a seismic source to generate signals that interact with the subsurface and seismic receivers that record seismic signals generated by the interaction of the subsurface with the signals from the seismic source,

Seismic inversion is the process of transforming seismic reflection data into a quantitative rock property description of a reservoir (e.g. acoustic impedance, shear impedance, and density). In effect, seismic inversion converts the recorded seismic signals into images, descriptions of the subsurface and/or properties thereof. Seismic inversion typically includes other reservoir measurements such as well logs and cores that contribute low frequency information below the seismic band and to constrain the inversion.

### SUMMARY

In general terms, the present disclosure provides methods and systems for constraining seismic models with real-time measurements. For example, methods and system may be provided for constraining a real-time inversion of a seismic convolution model with logging-while-drilling (LWD) measurements. In this way, information from the constrained model may be used in making drilling decisions, such as for landing and steering a wellbore that is being drilled as the LWD measurements are being made. As such, the present disclosure provides methods for converting seismic data from a subterranean section of the Earth other measurements associated with a borehole penetrating/being drilled into the subterranean section into information that can be used to control the drilling procedure. Measurement-while-drilling (MWD) measurements may be used to determine the performance of the drilling system and may be used to monitor/control the drilling procedure.

Accordingly, in a first aspect, embodiments of the present disclosure provide a method for constraining a seismic inversion using real-time measurements, where the method includes obtaining LWD and/or MWD measurements made during a drilling procedure, using the LWD measurements to constrain an inversion of seismic signal(s)/data, and using the inverted seismic signal/data to obtain an image of a subterranean section of the Earth, determine properties of the subterranean section of the Earth and/or update a model of the subterranean section of the Earth.

The method of the first aspect may have any one or, to the extent that they are compatible, any combination of the following optional features.

The method may be performed in real-time during the drilling procedure. In such a real-time method, the LWD and/or MWD measurements are typically obtained independent of the seismic signal/data.

The method may be performed multiple times during the drilling procedure. For example, as the drilling extends a well, and further LWD measurements are obtained, these further measurements can be used to constrain another inversion of the seismic signal/data, and this inverted seismic signal/data can be used to: obtain another image of a subterranean section of the Earth, determine more properties of the subterranean section of the Earth and/or further update a model of the subterranean section of the Earth. Thus the obtaining of LWD measurements, the use of the measurements to constrain an inversion, and the use of the inverted signal/data can be repeated as necessary.

The method may further comprise using at least one of the image of the subterranean section of the Earth, the determined properties of the subterranean section of the Earth and the updated a model of the subterranean section of the Earth to control the drilling procedure. Controlling the drilling procedure may comprise steering a drilling system, landing a well, managing rate of penetration of the drilling system, adjusting drilling parameters and/or the like.

A seismic convolution model may be used to invert the seismic signal and/or seismic data. The signal/data may be obtained/received during a drilling procedure into reflectivity data. The signal/data may be inverted into reflectivity data and may be used to identify reflector positions and/or amplitudes of seismic reflectors around and/or ahead of the drilled section of the well. The seismic signal/data may be generated by a seismic survey obtained while performing the drilling procedure, obtained from a prior seismic survey, and/or the like.

Deep and directional LWD may be used to obtain real-time information about the formation in which the wellbore is being drilled. For example, deep and directional electromagnetic LWD measurements, deep resistivity measurements, deep inductance measurements and/or the like may be used to obtain information about the formation around the wellbore and/or in front of the drill bit being used to drill the wellbore. This information about the formation may be used to update/analyze seismic data obtained from the formation. The formation information can be in 2D or 3D. The formation information can include the number of reflectors, the expected positions of the reflectors, the expected amplitudes of the reflectors and/or the polarity signs of the reflector amplitudes.

Seismic data obtained from a seismic survey may be used to create a model of the formation, and this model may be updated/analyzed using the LWD measurements. Seismic measurements may be made during the drilling procedure and this seismic measurements may be updated/analyzed using the LWD measurements. The LWD measurements may be incorporated into a seismic inversion, where the LWD measurements that are obtained independent of the seismic measurements may be used to constrain the seismic inversion.

The inversion of the seismic signal/data may comprise seismic super resolution inversion.

The method may further comprise estimating, from the seismic signal/data, a seismic wavelet for a region of interest in the subterranean section, the wavelet being used in the inversion of the seismic signal/data.

The constrained inversion of the seismic signal/data may involve optimization of an objective function specifying discrepancy between the seismic signal/data and the corresponding value obtained by convolving the wavelet with reflectivity data. The reflectivity data may incorporate the LWD measurements. The inversion may be further constrained by specifying lateral continuations of reflectors forming the reflectivity data.

The method may further comprise inverting the LWD measurements. The inverted seismic signal/data can then be fed back into the inversion of the LWD measurements, e.g. in an iterative inversion of both the LWD measurements and the seismic signal/data.

Further aspects of the present disclosure provide a computer program comprising code which, when run on a computer, causes the computer to perform the method of the first aspect; a computer readable medium storing a computer program comprising code which, when run on a computer, causes the computer to perform the method of the first aspect; and a computer system programmed to perform the method of the first aspect.

For example, a computer system can be provided for constraining a seismic inversion using real-time measurements the system including: one or more processors configured to: receive a seismic signal/seismic data; obtain logging-while-drilling measurements made during a drilling procedure; use the LWD measurements to constrain an inversion of the seismic signal/data; and use the inverted seismic signal/data to obtain an image of a subterranean section of the Earth, determine properties of the subterranean section of the Earth and/or update a model of the subterranean section of the Earth. The system thus corresponds to the method of the first aspect. The system may further include: a computer-readable medium or media operatively connected to the processors, the medium or media storing the seismic signal/data. The system may further include: a display device for displaying the obtained image of the subterranean section of the Earth, the determined properties of the subterranean section of the Earth and/or the updated model of the subterranean section of the Earth. The system may further include sensors for obtaining the LWD/MWD measurements and/or telemetry systems for communicating the LWD/MWD measurements from the sensor to the processor. In some aspects, the processor may be disposed downhole in the borehole. In some aspects the processor may be disposed at or near the surface of the Earth.

A further aspect of the present disclosure provides a drilling system including a drillstring located in a borehole, the drillstring including one or more LWD/MWD modules; and a computer system according to the previous aspect for constraining a seismic inversion using real-time measurements from the modules. The modules may comprise sensors for making LWD/MWD measurements.

### BRIEF DESCRIPTION OF THE DRAWINGS

Embodiments of the present disclosure will now be described by way of example with reference to the accompanying drawings in which:

FIG. 1 illustrates a drilling system for operation at a wellsite to drill a borehole through an earth formation;

FIG. 2 shows schematically a convolution model with (A) a reflectivity model represented by a set of reflector positions and amplitudes, and (B) a wavelet (left) convolved with the reflectivity model (middle) resulting in a seismic trace (right);

FIG. 3 is a synthetic example illustrating the estimated reflectivity uncertainty from a stochastic seismic super resolution inversion, the center black curve being the exact signal resulting from convolution of the reflectivity model with a wavelet, while the grey curves show the convolved signal of the 1%, 10%, 25%, 75%, 90% and 99% quantiles of the reflectivity;

FIG. 4 shows schematically seismic super resolution inversion and a look-ahead application; and

FIG. 5 shows a workflow which integrates LWD measurements into a seismic super resolution inversion.

In the appended figures, similar components and/or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label. Additionally, it is emphasized that, in accordance with the standard practice in the industry, various features are not drawn to scale. In fact, the dimensions of the various features may be arbitrarily increased or reduced for clarity of discussion.

### DETAILED DESCRIPTION AND FURTHER OPTIONAL FEATURES

The ensuing description provides preferred exemplary embodiment(s) only, and is not intended to limit the scope, applicability or configuration of the invention. Rather, the ensuing description of the preferred exemplary embodiment(s) will provide those skilled in the art with an enabling description for implementing a preferred exemplary embodiment of the invention. It being understood that various changes may be made in the function and arrangement of elements without departing from the spirit and scope of the invention as set forth in the appended claims.

Specific details are given in the following description to provide a thorough understanding of the embodiments. However, it will be understood by one of ordinary skill in the art that the embodiments maybe practiced without these specific details. For example, circuits may be shown in block diagrams in order not to obscure the embodiments in unnecessary detail. In other instances, well-known circuits, processes, algorithms, structures, and techniques may be shown without unnecessary detail in order to avoid obscuring the embodiments.

Also, it is noted that the embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in the figure. A process may correspond to a method, a function, a procedure, a subroutine, a subprogram, etc. When a process corresponds to a function, its termination corresponds to a return of the function to the calling function or the main function.

Moreover, as disclosed herein, the term “storage medium” may represent one or more devices for storing data, including read only memory (ROM), random access memory (RAM), magnetic RAM, core memory, magnetic disk storage mediums, optical storage mediums, flash memory devices and/or other machine readable mediums for storing information. The term “computer-readable medium” includes, but is not limited to portable or fixed storage devices, optical storage devices, wireless channels and various other mediums capable of storing, containing or carrying instruction(s) and/or data.

Furthermore, embodiments may be implemented by hardware, software, firmware, middleware, microcode, hardware description languages, or any combination thereof. When implemented in software, firmware, middleware or microcode, the program code or code segments to perform the necessary tasks may be stored in a machine readable medium such as storage medium. A processor(s) may perform the necessary tasks. A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

It is to be understood that the following disclosure provides many different embodiments, or examples, for implementing different features of various embodiments. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed. Moreover, the formation of a first feature over or on a second feature in the description that follows may include embodiments in which the first and second features are formed in direct contact, and may also include embodiments in which additional features may be formed interposing the first and second features, such that the first and second features may not be in direct contact.

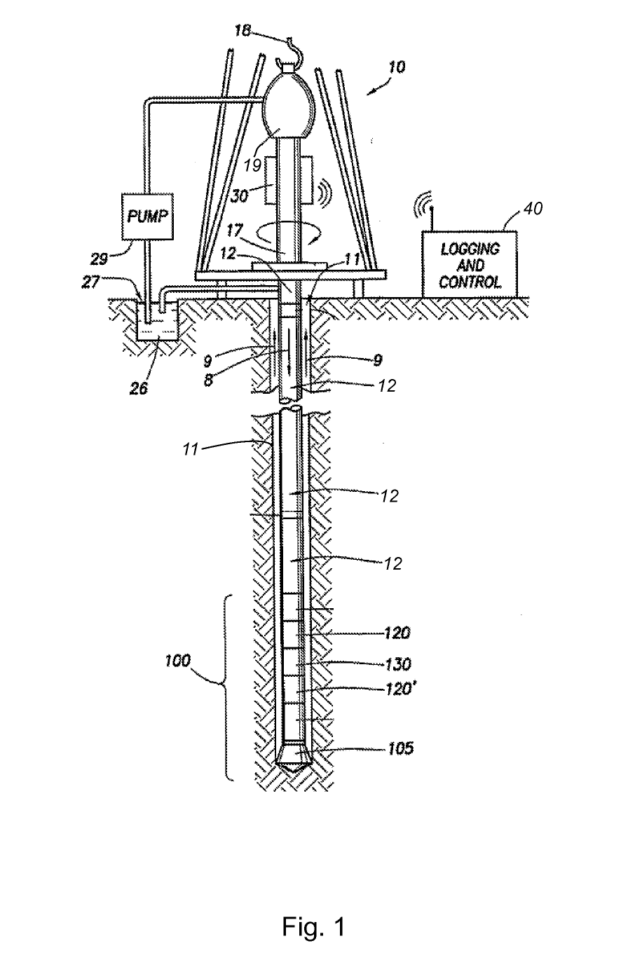

FIG. 1 illustrates a drilling system for operation at a wellsite to drill a borehole through an earth formation. The wellsite can be located onshore or offshore. In this system, a borehole 11 is formed in subsurface formations by rotary drilling in a manner that is well known. Systems can also use be used in directional drilling systems, pilot hole drilling systems, casing drilling systems and/or the like.

A drillstring 12 is suspended within the borehole 11 and has a bottomhole assembly 100, which includes a drill bit 105 at its lower end. The surface system includes a platform and derrick assembly 10 positioned over the borehole 11, the assembly 10 including a top drive 30, kelly 17, hook 18 and rotary swivel 19. The drillstring 12 is rotated by the top drive 30, energized by means not shown, which engages the kelly 17 at the upper end of the drillstring. The drillstring 12 is suspended from the hook 18, attached to a traveling block (also not shown), through the kelly 17 and the rotary swivel 19 which permits rotation of the drillstring relative to the hook. As is well known, a rotary table system could alternatively be used to rotate the drillstring 12 in the borehole and, thus rotate the drill bit 105 against a face of the earth formation at the bottom of the borehole.

The surface system can further include drilling fluid or mud 26 stored in a pit 27 formed at the well site. A pump 29 delivers the drilling fluid 26 to the interior of the drillstring 12 via a port in the swivel 19, causing the drilling fluid to flow downwardly through the drillstring 12 as indicated by the directional arrow 8. The drilling fluid exits the drillstring 12 via ports in the drill bit 105, and then circulates upwardly through the annulus region between the outside of the drillstring and the wall of the borehole, as indicated by the directional arrows 9. In this well-known manner, the drilling fluid lubricates the drill bit 105 and carries formation cuttings up to the surface as it is returned to the pit 27 for recirculation.

A control unit 40 may be used to control the top drive 30 or other drive system. The top drive 30 may rotate the drillstring 12 at a rotation speed to produce desired drilling parameters. By way of example, the speed of rotation of the drillstring may be: determined so as to optimize a rate of penetration through the earth formation, set to reduce drill bit wear, adjusted according to properties of the earth formation, or the like.

The bottomhole assembly 100 may include a logging-while-drilling (LWD) module 120, a measuring-while-drilling (MWD) module 130, a rotary-steerable system and motor, and drill bit 105.

The MWD module 130 may be housed in a special type of drill collar, as is known in the art, and can contain one or more devices for measuring characteristics of the drillstring and drill bit. The MWD tool may further includes an apparatus (not shown) for generating electrical power to the downhole system. This may typically include a mud turbine generator powered by the flow of the drilling fluid, it being understood that other power and/or battery systems may be employed. The MWD module may include one or more of the following types of measuring devices: a weight-on-bit measuring device, a torque measuring device, a vibration measuring device, a shock measuring device, a stick slip measuring device, a direction measuring device, a rotation speed measuring device, and an inclination measuring device.

The LWD module 120 may also be housed in a special type of drill collar, as is known in the art, and can contain one or a plurality of known types of logging tools. It will also be understood that more than one LWD and/or MWD module can be employed, e.g. as represented at 120′. The LWD module may include capabilities for measuring, processing, and storing information, as well as for communicating with the surface equipment. The LWD module may include a fluid sampling device. Typical LWD include, for example, natural gamma ray, spectral density, neutron density, inductive and galvanic resistivity, acoustic velocity, acoustic caliper, downhole pressure, and the like. Formations having recoverable hydrocarbons typically include certain well-known physical properties, for example, resistivity, porosity (density), and acoustic velocity values in a certain range.

Advantageously, the LWD measurements may be used in seismic super resolution, where information is extracted from an interference pattern in seismic data using knowledge of underlying variables, from the LWD measurements, influencing the seismic signal. Seismic super resolution is described in H. G. Borgos, T. Randen and L. Sonneland, SUPER-RESOLUTION MAPPING OF THIN GAS POCKETS, 65th EAGE Conference and Exhibition, Stavanger, Norway (2003). In embodiments of the present invention, the concept of seismic super resolution may be extended to real time applications utilizing information about the geologic formations obtained from LWD measurements.

One example of LWD measurements providing an imaging of the formation/subterranean sections of the Earth is provided by electromagnetic (EM) LWD measurements. For example, a directional EM tool, as described by Dupuis et al. (C. Dupuis, D. Omeragic, Y. H. Chen and T. Habashy, WORKFLOW TO IMAGE UNCONFORMITIES WITH DEEP ELECTROMAGNETIC LWD MEASUREMENTS ENABLES WELL PLACEMENT IN COMPLEX SCENARIOS, SPE 1661 17 (2013)) provides measurements with a penetration depth of up to about 100 feet (30 meters), which are fed into an inversion algorithm to produce an image of the formations around the trajectory of the well.

Previously, seismic super resolution constrained a seismic inversion into reflectivity, with the number of reflectors and their respective polarities at best observed at 1D locations of one or a few wells intersecting these reflectors. However, according to the present invention, the seismic inversion may be constrained with additional 2D or 3D information on the expected positions and amplitudes of the reflectors provided continuously along the trajectory of a wellbore drilled within a target formation, without the need to intersect the reflectors. The seismic super resolution inversion typically requires knowledge of the seismic wavelet, which can be estimated from the seismic measurements (see e.g. K. F. Karesen and T, Taxt, MULTICHANNEL BLIND DECONVOLUTION OF SEISMIC SIGNALS, Geophysics 63, 2093-2107 (1998), and M. Nickel, O. Arild, M. Ostebo, O. Haugen, and L. Sonneland, A 3D STOCHASTIC APPROACH FOR SEISMIC REFLECTOR DETECTION, 6151 EAGE Conference and Exhibition, Helsinki, Finland (1999)).

Inversion of a seismic signal to obtain an image of and/or determine a physical property of a subterranean section of the Earth can be problematic, since it is an ill-posed inversion problem with a non-unique solution, due to limited band width and measurement noise. However, the inventors have found that LWD measurements can produce meaningful/useful constraints for seismic inversion. Thus, according to the present invention, inversion of the seismic signal can be constrained by LWD measurements. These constraints can be used to narrow the range of possible inversion solutions, thus reducing the uncertainty of the inversion result. The inversion may be performed in real-time, producing an image of the subterranean section of the Earth, while a wellbore is being drilling through the subterranean section. The image of and/or physical property(ies) of the subterranean section of the Earth produced from the inversion may be used to control the drilling procedure. In some aspects, the drilling procedure may be automated and the image of and/or physical property(ies) of the subterranean section of the Earth may be used in the automated drilling procedure. In such aspects, LWD measurements may be used in real-time to constrain seismic inversion of seismic data to obtain information about the subterranean section of the Earth being drilled so that the automated drilling process can make decisions as to how to proceed with the drilling operation.

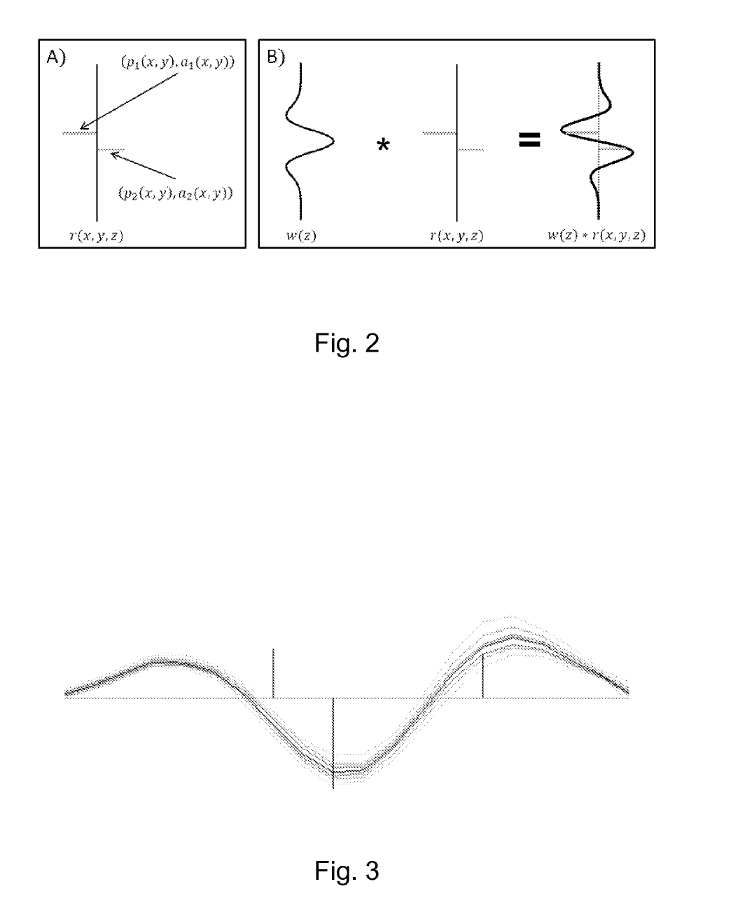

The LWD measurements can be used as constraints for inversion of a seismic convolution model to obtain an image of reflectivity. When multiple strong reflectors are located vertically close to each other in the subsurface, the seismic signal produced exhibits an interference pattern between the wavelet and the different reflections. In such an interference pattern, referred to as seismic tuning, the reflector positions and amplitudes cannot be derived from peaks or troughs (minima or maxima) in the seismic signal. Instead, the reflector positions and amplitudes may be derived from inverting a convolution model of the seismic signal in the tuning region, referred to as seismic super resolution. FIG. 2 shows schematically a convolution model with (A) a reflectivity model represented by a set of reflector positions and amplitudes, and (B) a wavelet (left) convolved with the reflectivity model (middle) resulting in a seismic trace (right). The seismic super resolution typically requires as input a seismic wavelet representative for the region of interest. The wavelet can, for example, be estimated from the seismic data.

Seismic Super Resolution

The seismic super resolution method is based on a seismic convolution model:

s(x,y,z)=w(z)*r(x,y,z)+u(x,y,z).

The convolution model describes how an observed seismic sample s(x, y, z) at lateral location (x, y) and vertical position (time or depth) z is the result of a convolution between a wavelet w(z) (assumed known) and the unknown reflectivity r(x, y, z) of the underground, plus some unknown noise u(x, y, z).

The inversion of the seismic observations into reflectivity can be phrased as an optimization problem:

r*(x,y,z)=argmin fₛ(r(x,y,z)).

The Objective Function:

fₛ(r(x,y,z))=fₛ(w(z)*r(x,y,z),s(x,y,z))

measures the discrepancy between the observed seismic signal and the corresponding value obtained by convolving the wavelet with the reflectivity. The inversion result r*(x, y, z) is the reflectivity for which the objective function obtains its minimum value.

In the seismic super resolution inversion, the reflectivity is represented through a limited number of n reflectors at positions pᵢ(x, y) with corresponding amplitudes aᵢ (x, y) (see FIG. 2):

r(x,y,z)=aᵢ(x,y) when z=pᵢ(x,y), i=1, . . . , n

r(x,y,z)=0, else

The seismic super resolution inversion may be constrained by incorporating knowledge about the reflectors obtained from other sources of data, e.g., the number n of reflectors, the polarity sign(aᵢ(x, y)) of the reflector amplitudes, and/or the expected absolute or relative positions and amplitudes {mₚᵢ(x, y), mₐᵢ(x, y)}=_{i=1, . . . , n} of the reflectors. Further constraints may be obtained by including objective functions for the lateral continuation of the reflectors. The constrained inversion can be phrased as an optimization problem:

r*(x,y,z)=argmin fₛ(r(x,y,z))fᵣ(r(x,y,z)),

where:

fᵣ(r(x,y,z))= [symbol] _{i=1, . . . ,n}fₚ(pᵢ(x,y);mₚᵢ(x,y))fₐ(aᵢ(x,y);mₐᵢ(x,y))* [symbol] _{(x,y)˜(x′,y′)}gₚ(pᵢ(x,y)),pᵢ(x′,y′)gₐ(aᵢ(x,y),aᵢ(x′,y′))

The objective functions for the reflector positions:

fₚ(pᵢ(x,y);mₚᵢ(x,y)),

and amplitudes:

fₐ(aᵢ(x,y);mₐᵢ(x,y)),

measure the discrepancy between reflector positions and amplitudes and their respective expected values. And:

gₚ(pᵢ(x,y),pᵢ(x′,y′))

and

gₐ(aᵢ(x,y),aᵢ(x′,y′))

measure the continuity of the reflectors between neighbour locations:

(x,y)˜(x′,y′).

The inversion result r*(x, y, z) is the optimal reflector positions and amplitudes with respect to: (1) the fit of the convolution model to the observed seismic data; (2) the deviation from the expected reflector positions and amplitudes; and (3) the continuity of the reflectors.

Example: Stochastic Seismic Super Resolution

One example of a seismic super resolution optimization scheme is a Bayesian stochastic optimization where the objective functions are derived from a likelihood model and a prior model. The likelihood model is defined through a probability density function describing the distribution of the seismic observations, given the underlying, unknown reflectivity (assuming the wavelet is known):

π(s(x,y,z)|r(x,y,z))

This likelihood function incorporates the convolution model and the probability distribution of the noise term u(x, y, z). The prior model describes any knowledge about the reflectivity available independent of the seismic observations, with uncertainty, and is defined through a probability density function:

π(r(x,y,z)).

From Bayes' theorem, the posterior probability distribution, which is proportional to the product of the likelihood and the prior, is given by:

π(r(x,y,z)|s(x,y,z))=const*π(s(x,y,z)|r(x,y,z))π(r(x,y,z)).

The stochastic inversion result is the reflectivity r*(x, y, z) maximizing the posterior distribution:

$$\begin{matrix}{r}^{*} ( x , y , z ) = argmax π ( r ( x , y , z ) \vert s ( x , y , z ) ) \\ = argmax π ( s ( x , y , z ) \vert r ( x , y , z ) ) π ( r ( x , y , z ) )\end{matrix}$$

In addition, the posterior distribution also provides a measure of uncertainty of the inverted reflectivity. For example, FIG. 3 is a synthetic example illustrating the estimated reflectivity uncertainty from a stochastic seismic super resolution inversion, the center black curve being the exact signal resulting from convolution of the reflectivity model with a wavelet, while the grey curves show the convolved signal of the 1%, 10%, 25%, 75%, 90% and 99% quantiles of the reflectivity.

Any maximization may be converted to a minimization by negating the objective functions.

By comparison with the general seismic super resolution optimization described above, a stochastic seismic super resolution may be obtained by defining the objective function:

fₛ(r(x,y,z))

based on the likelihood function:

π(s(x,y,z)|r(x,y,z)),

and the objective functions:

fᵣ(r(x,y,z))

based on the prior distribution:

π(r(x,y,z)).

Incorporating LWD Measurements

The seismic super resolution may be constrained by prior knowledge about reflectivity provided from LWD measurements. The LWD constraints of the seismic inversion may be applicable both: (1) in real-time along the well-trajectory, where LWD measurements of the same underground/subterranean section as produced the seismic signals/measurements are available; and (2) in continuation beyond the drill bit in a look-ahead application. Applied in real-time, the look-ahead application can provide new information about the yet undrilled part of the formation, which can be applied in planning the further steering of the well.

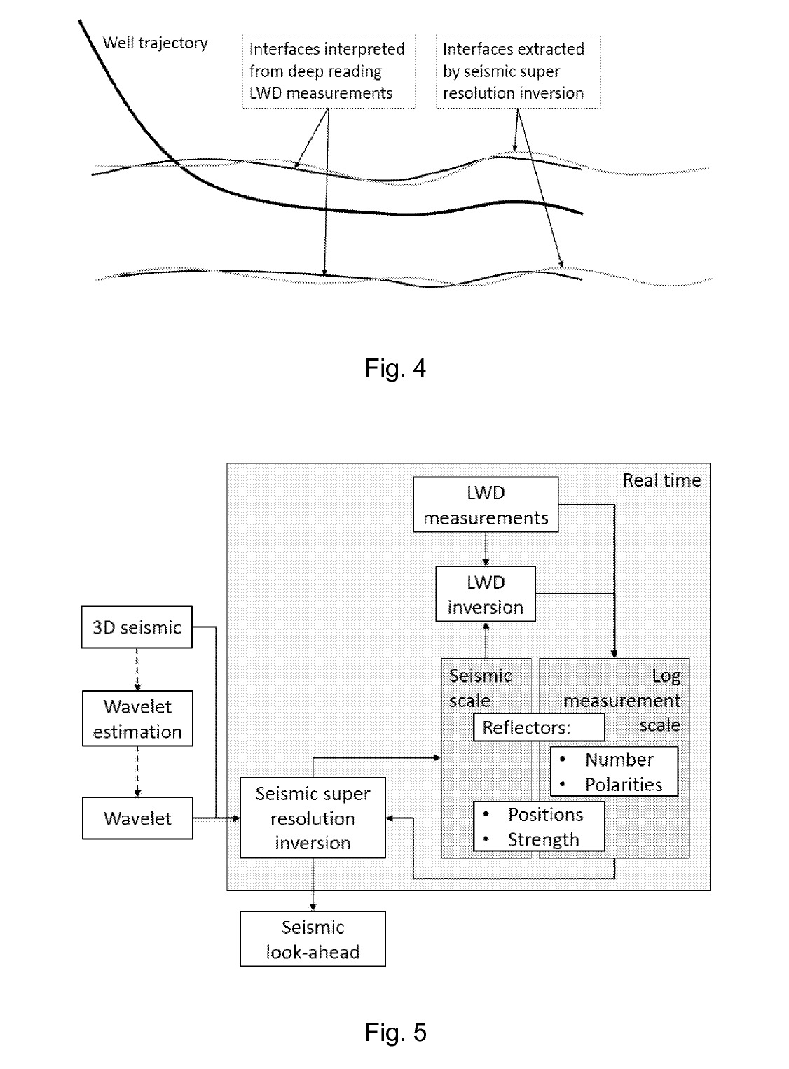

FIG. 4 shows schematically seismic super resolution inversion and the look-ahead application. Deep reading LWD measurements are obtained along the well trajectory, providing expected interfaces vertically above and below the well trajectory. Corresponding interfaces are mapped from the seismic signal, constraining the seismic super resolution inversion with the interpreted interfaces (with uncertainty). The interfaces extracted from the seismic data extend beyond the head of the well, providing a seismic look-ahead.

FIG. 5 shows a workflow which integrates LWD measurements into a seismic super resolution inversion.

Real-Time

The objective function:

fᵣ(r(x,y,z))

incorporates prior knowledge about the reflectivity into the seismic super resolution, as described above, by adding information, e.g., about the expected reflector positions and amplitudes. LWD measurements from a horizontally drilled well provide information about the target formation laterally along the well trajectory. In particular, deep directional measurements (e.g., resistivity obtained from deep directional electromagnetic measurements and/or the like) with a high penetration depth are able to map, in 2D or 3D, as contrasts in the measurements, the position of the top and base of the formation above and below the well trajectory. Interfaces interpreted from the deep reading LWD measurements provide expected seismic reflector positions mₚᵢ(x, y).

Furthermore, through empirical relationships (optionally calibrated to well-logs) the deep reading LWD measurements may be converted to reflection coefficients, providing expected seismic reflector amplitudes mₐᵢ(x, y). The LWD measurements can be processed by an inversion step and the results of the seismic super resolution inversion can be fed back into the inversion step of the LWD measurements, e.g. in an iterative inversion of both the LWD data and the seismic signal, as indicated in FIG. 5.

Seismic Look-Ahead

In situations where LWD measurements are not available for the same underground/subterranean area as produced the seismic signals/measurements, such as in a seismic look-ahead setting, where seismic signals are obtainable or have been obtained for the subterranean location in front of the drill bit, but LWD measurements for this location/area are not possible or not yet obtained, a geologically consistent extrapolation may be made from the available LWD measurements about the reflectors, e.g., the number of reflectors, the polarity of the reflectors, expected positions of or distances between the reflectors, expected amplitudes of the reflectors and/or the like. This extrapolated information may be used in the seismic super resolution for the location/area ahead of the drill bit to narrow the solution range of the inversion compared to the non-unique unconstrained inversion. Furthermore, any general parameterization of the objective functions:

fₛ(r(x,y,z)) and fᵣ(r(x,y,z))

may be optimized for the current formation being drilled, based on the section that contains both seismic observations and LWD measurements of the same underground. Performing the seismic super resolution inversion ahead of the drill bit provides an image of the underground on which decisions on further steering of the well through the formation can be made.

All references referred to above are hereby incorporated by reference for all purposes.

1. A method for constraining a seismic inversion using real-time measurements, comprising:
receiving a seismic signal/seismic data;
obtaining logging-while-drilling (LWD) measurements made during a drilling procedure;
using the LWD measurements to constrain an inversion of the seismic signal/data; and
using the inverted seismic signal/data to obtain an image of a subterranean section of the Earth, determine properties of the subterranean section of the Earth, and/or update a model of the subterranean section of the Earth.

2. The method of claim 1, wherein the method is performed in real time during the drilling procedure.

3. The method of claim 1, further comprising:
using at least one of the image of the subterranean section of the Earth, the determined properties of the subterranean section of the Earth, and the updated model of the subterranean section of the Earth to control the drilling procedure.

4. The method of claim 3, wherein controlling the drilling procedure comprises steering a drilling system or landing a well.

5. The method of claim 1; wherein the inversion of the seismic signal/data comprises an inversion of a seismic convolution model.

6. The method of claim 1, wherein the seismic signal/data is/are inverted into a reflectivity identifying reflector positions and amplitudes of seismic reflectors around and/or ahead of a drilled section of well bore being drilled in the drilling procedure.

7. The method of claim 1, wherein the inversion of the seismic signal/data comprises seismic super resolution inversion.

8. The method of claim 1, wherein the LWD measurements provide an expected number of reflectors, amplitudes of reflectors, positions of reflectors, and/or distances between reflectors.

9. The method of claim 1, further comprising:
estimating, from the seismic signal/data, a seismic wavelet for a region of interest in the subterranean section, the wavelet being used in the inversion of the seismic signal/data.

10. The method of claim 1, wherein the LWD measurements comprise deep and directional electromagnetic LWD measurements, deep resistivity measurements, and/or deep inductance measurements.

11. The method of claim 1, wherein the obtaining of the LWD measurements, the use of the LWD measurements to constrain an inversion of the seismic signal/data, and the use of the inverted seismic signal/data are repeated multiple times.

12. A computer program comprising code which, when run on a computer, causes the computer to perform the method of claim 1.

13. A computer readable medium storing a computer program comprising code which, when run on a computer, causes the computer to perform the method of claim 1.

14. A computer-based control system programmed to perform the method of claim 1.

15. A drilling system including:
a steerable or landable drillstring located in a borehole, the drillstring including one or more logging-while-drilling (LWD) modules; and
a computer readable medium storing a computer program comprising code configured when run on a computer to cause the computer to:
receive a seismic signal/seismic data,
obtain LWD measurements made during a drilling procedure,
use the LWD measurements to constrain an inversion of the seismic signal/data, and
use the inverted seismic signal/data to obtain an image of a subterranean section of the Earth, determine properties of the subterranean section of the Earth, and/or update a model of the subterranean section of the Earth;
wherein the computer readable medium is configured to constrain a seismic inversion using real-time measurements from the LWD modules.
